(19) United States
(12) Patent Application Publication
(10) Pub. No.: US 2026/0093148 A1
(43) Pub. Date: Apr. 2, 2026

(54) LIQUID CRYSTAL OPTICAL DEVICE AND APPARATUS COMPRISING THE SAME

(71) Applicant: Flexenable Technology Limited, Cambridge (GB)

(72) Inventors: Will Reeves, Cambridge (GB); May Wheeler, Cambridge (GB); James Harding, Cambridge (GB)

(21) Appl. No.: 19/485,973

(22) PCT Filed: May 17, 2024
(86) PCT No.: PCT/EP2024/063798

§ 371 Date: Dec. 11, 2025

(30) Foreign Application Priority Data
May 19, 2023 (GB) 2307548.4

(51) Int. Cl. G02F 1/1343

(52) U.S. Cl. CPC G02F 1/13439

(57) ABSTRACT

An optical device comprising: at least one liquid crystal cell comprising liquid crystal material in a cell gap having a dimension at least partly defined by spacers, the liquid crystal cell comprising electrodes for inducing substantially confocal refractive index patterns in substantially concentric, first regions of the liquid crystal material; and within an area bound by an outer edge of an outermost one of the first regions, the spacers being at least disproportionately located in one or more re-set regions between the first regions.

Some optical devices comprise at least one liquid crystal cell comprising liquid crystal (LC) material in a cell gap having a dimension at least partly defined by spacers, and electrodes for inducing one or more refractive index patterns in the LC material.

Controlled arrangements of spacers may be achieved by patterning one or more layers of one or more spacer materials.

Examples are described in detail hereunder, by way of example only, with reference to the accompanying drawings, in which:

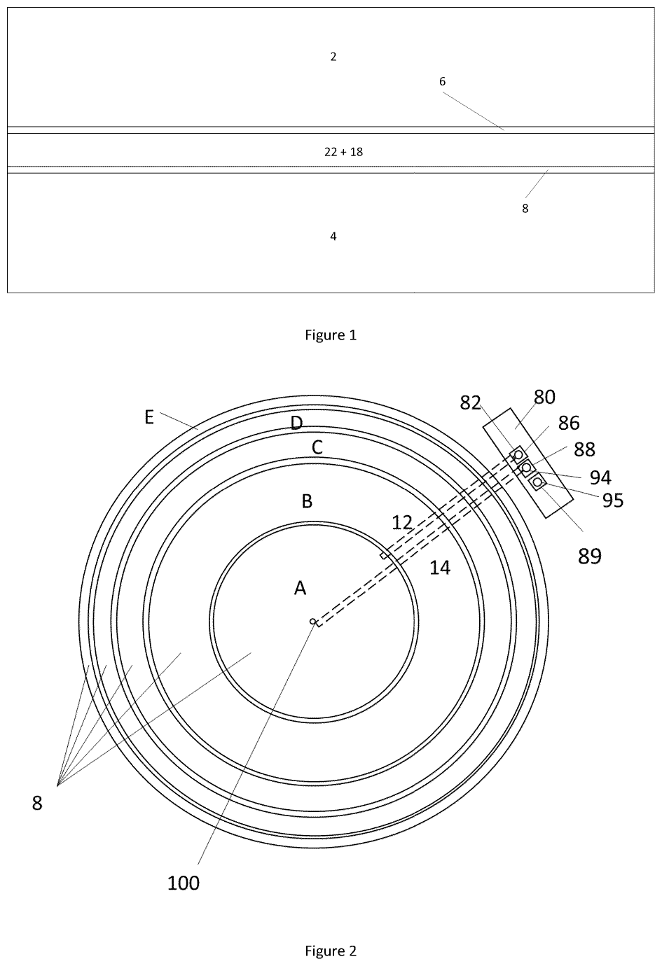

FIG. 1 shows a representation of one example of an architecture for a device for inducing one or more refractive index patterns in liquid crystal material;

FIG. 2 shows a representation of one example of groups of concentric electrodes for inducing confocal refractive index patterns in liquid crystal material;

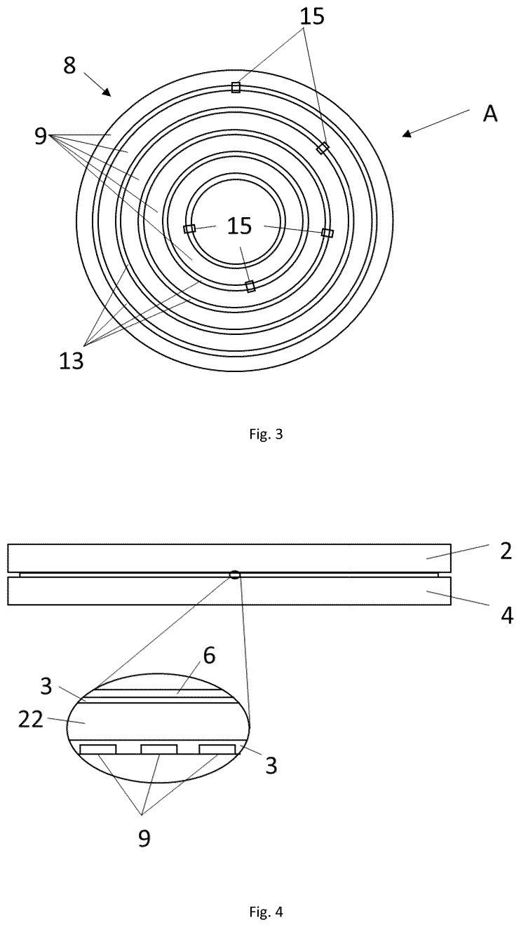

FIG. 3 shows a representation of an example for the radially innermost group of concentric conductor rings in FIG. 2;

FIG. 4 shows a cross-sectional representation of a device including the Fresnel groups of concentric conductor rings of FIG. 2;

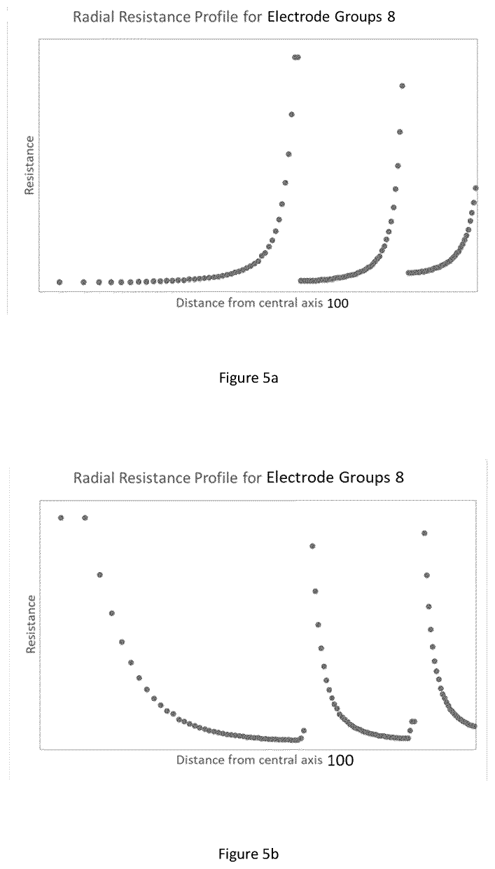

FIGS. 5a and 5b show a representation of examples of radial resistance profiles for the example of three Fresnel groups of concentric electrodes for inducing confocal refractive index patterns in liquid crystal material;

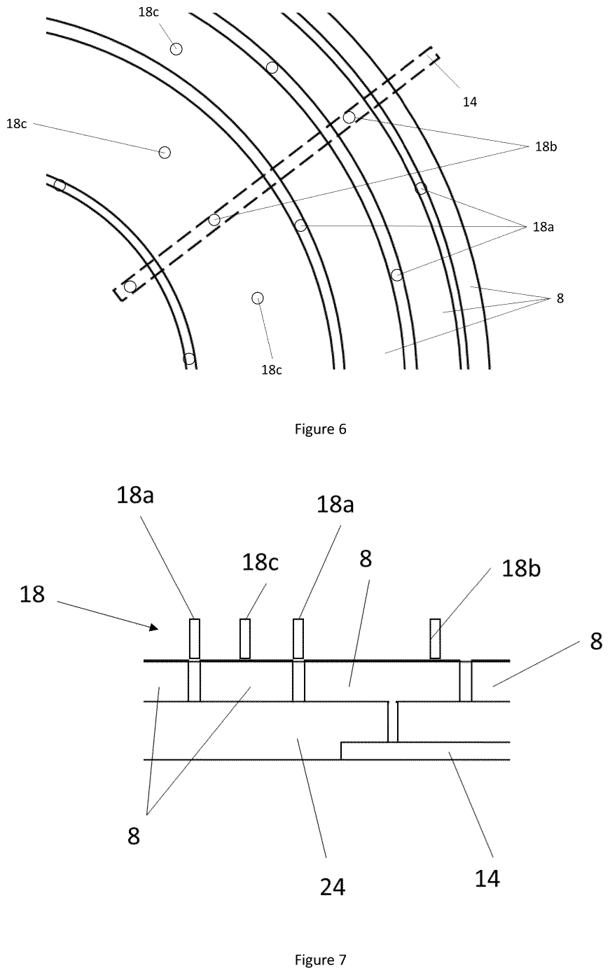

FIG. 6 shows a representation of one example of locating spacers;

FIG. 7 shows another representation of one example of locating spacers;

FIG. 8 shows a representation of one example of applying a power supply across each of the electrode groups in parallel;

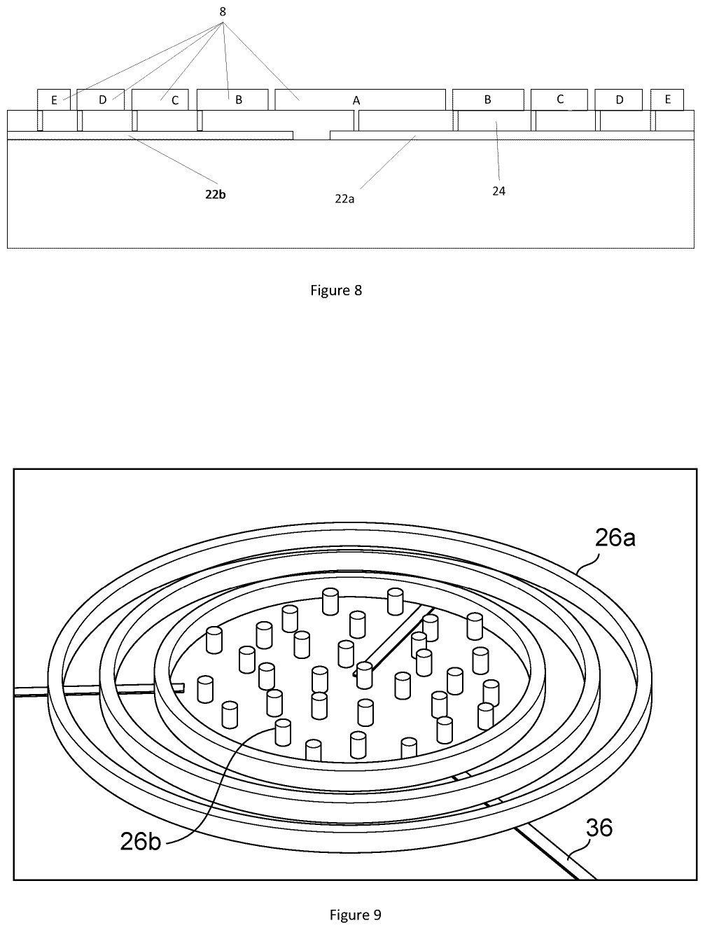

FIG. 9 shows a representation of one example of a technique for reducing scattering by spacers;

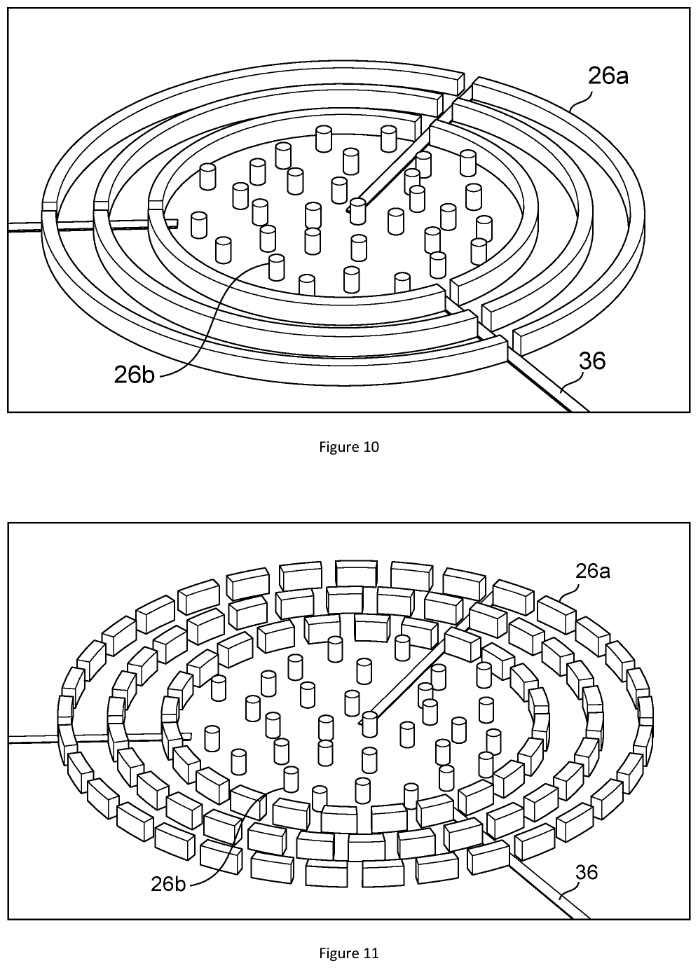

FIG. 10 shows a representation of one example of an arrangement of spacers;

FIG. 11 shows a representation of another example of an arrangement of spacers;

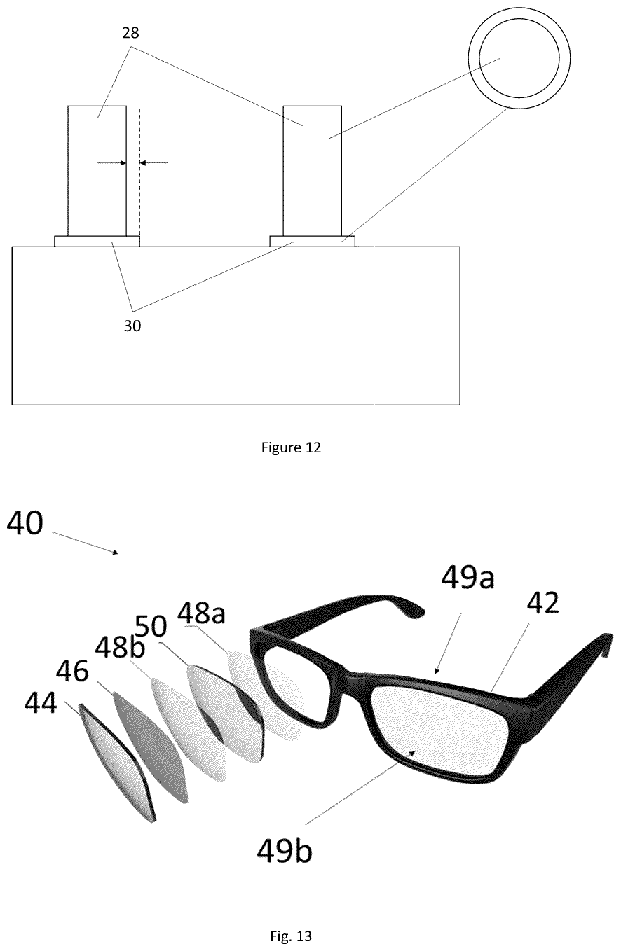

FIG. 12 shows a representation of another example of an arrangement of spacers.

FIG. 13 shows an example of a headset incorporating a liquid crystal, adaptive optical lens;

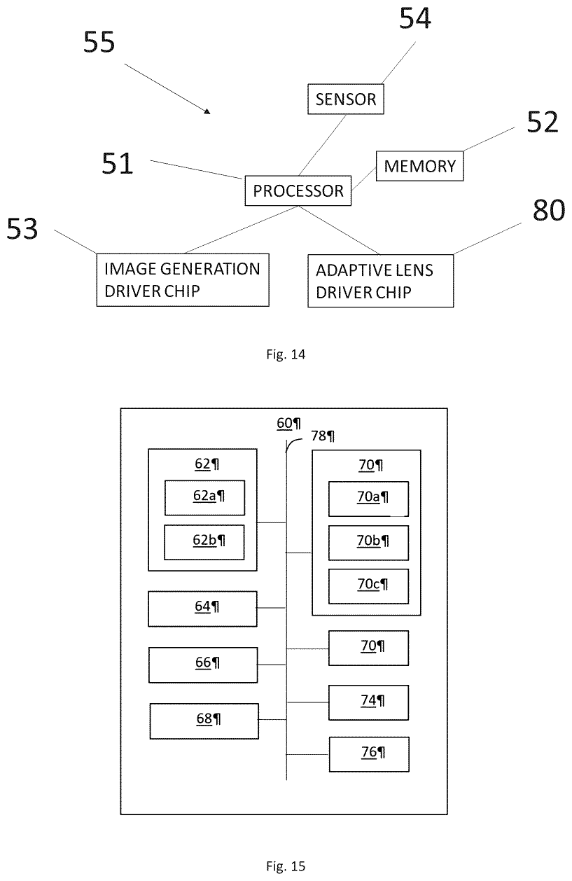

FIG. 14 shows a representation of an example of a system for operating the headset of FIG. 13; and

FIG. 15 shows schematically an example of apparatus.

An optical device comprising: at least one liquid crystal cell comprising liquid crystal material in a cell gap having a dimension at least partly defined by spacers, the liquid crystal cell comprising electrodes for inducing substantially confocal refractive index patterns in substantially concentric, first regions of the liquid crystal material; and within an area bound by an outer edge of an outermost one of the first regions, the spacers being at least disproportionately located in one or more re-set regions between the first regions.

The spacers may exhibit a higher absorbance for visible light than the liquid crystal material.

The spacers may comprise at least one spacer centered in one of the re-set regions.

The spacers may comprise column spacers; and wherein within the area bound by the outer edge of the outermost one of the first regions, the column spacers may be at least disproportionately located in one or more re-set regions between the first regions.

The spacers may comprise column spacers dotted within the area bound by an outer edge of the outermost one of the first regions; and wherein within the area bound by the outer edge of the outermost one of the first regions, the column spacers may be at least disproportionately located in one or more re-set regions between the first regions.

The column spacers may be electrically insulating.

The column spacers may comprise column spacers located in the first regions; and the column spacers may comprise at least one column spacer located on a light-absorbing island, the light absorbing island having a larger diameter than the column spacer and exhibiting a higher absorbance in the visible spectrum than the column spacer.

The spacers may comprise at least one annular spacer located in the one or more re-set regions, wherein the annular spacer may be substantially concentric with the first regions.

The annular spacer may define one or more gaps to allow the movement of liquid crystal material between adjacent first regions.

The optical device may be operable as an adaptive optical lens.

The optical device may be operable as an optical lens switchable between different optical powers.

An assembly comprising: at least one liquid crystal cell comprising liquid crystal material in a cell gap having a dimension at least partly defined by spacers, the liquid crystal cell comprising electrodes for inducing substantially confocal refractive index patterns in substantially concentric, first regions of the liquid crystal material; and within the area bound by the outer edge of the outermost one of the first regions, the spacers being at least disproportionately located in one or more re-set regions between the first regions; and at least one further optical element.

The at least one further optical element may comprise at least one of: a waveguide, a luminance adjustment component, a lens, an image generation device, a reflection-reduction layer, or a protective layer.

Apparatus comprising: at least one liquid crystal cell comprising liquid crystal material in a cell gap having a dimension at least partly defined by spacers, the liquid crystal cell comprising electrodes for inducing substantially confocal refractive index patterns in substantially concentric, first regions of the liquid crystal material; and within the area bound by the outer edge of the outermost one of the first regions, the spacers being at least disproportionately located in one or more re-set regions between the first regions; at least one processor; and at least one storage comprising instructions, the instructions configured to, with the at least one processor, cause the apparatus to activate the electrodes to induce the substantially confocal refractive index patterns in substantially concentric, first regions of the liquid crystal material.

The apparatus may be configured to be mounted on a human head with the liquid crystal cell positioned in a field of view of an eye of the human head.

The apparatus may comprise: a first lens comprising a first one of the liquid crystal cell; and a second lens comprising a second one of the liquid crystal cell.

The field of view of the eye is a first field of view of a first eye, and the first lens may be configured to be positioned in the first field of view, in use, and the second lens may be configured to be positioned in a second field of view of a second eye of the human head, in use.

The electrodes may be grouped into concentric groups for inducing the substantially confocal refractive index patterns in respective regions of the liquid crystal material; and the instructions may be configured to, with the at least one processor, cause the apparatus to apply an electrical potential difference across the concentric groups in parallel.

The apparatus may be at least one of: an augmented reality display device, a virtual reality display device or a mixed reality display device.

An optical device, comprising: at least one liquid crystal cell comprising liquid crystal material in a cell gap having a dimension at least partly defined by spacers, and comprising substantially concentric electrodes for inducing one or more refractive index patterns in the liquid crystal material; and within the area bound by the outer edge of the outermost concentric electrode, the spacers being at least disproportionately located in regions occupied by underlying elements exhibiting a higher absorbance for visible light than the liquid crystal material.

The elements exhibiting a higher absorbance for visible light than the liquid crystal material may comprise one or more of: metal conductor lines.

The elements exhibiting a higher absorbance for visible light than the liquid crystal material may comprise elements whose primary function is to substantially block transmission in regions unoccupied by the concentric electrodes.

The concentric electrodes may be grouped into concentric groups for inducing substantially confocal refractive index patterns in respective regions of the liquid crystal material, wherein the concentric electrodes within a group are connected in electrical series via links having a higher electrical resistance than the concentric electrodes; and the groups are connected in parallel to a power supply; and wherein the elements whose primary function is to substantially block transmission in regions unoccupied by the concentric electrodes comprise elements whose primary function is to substantially block transmission in regions between adjacent groups of concentric electrodes.

The spacers may be defined by a patterned layer of spacer material.

The optical device may be operable as an adaptive optical lens.

The optical device may be operable as an optical lens switchable between different optical powers.

An assembly comprising: at least one liquid crystal cell comprising liquid crystal material in a cell gap having a dimension at least partly defined by spacers, and comprising substantially concentric electrodes for inducing one or more refractive index patterns in the liquid crystal material; and within the area bound by the outer edge of the outermost concentric electrode, the spacers being at least disproportionately located in regions occupied by underlying elements exhibiting a higher absorbance for visible light than the liquid crystal material; and at least one further optical element. The at least one further optical element may comprise at least one of: a waveguide, a luminance adjustment component, a lens, an image generation device, a reflection-reduction layer, or a protective layer.

Apparatus comprising: at least one liquid crystal cell comprising liquid crystal material in a cell gap having a dimension at least partly defined by spacers, and comprising substantially concentric electrodes for inducing one or more refractive index patterns in the liquid crystal material; and within the area bound by the outer edge of the outermost concentric electrode, the spacers being at least disproportionately located in regions occupied by underlying elements exhibiting a higher absorbance for visible light than the liquid crystal material; at least one processor; and at least one storage comprising instructions, the instructions configured to, with the at least one processor, cause the apparatus to activate the electrodes to induce the one or more refractive index patterns in the liquid crystal material.

The apparatus may be configured to be mounted on a human head with the liquid crystal cell positioned in a field of view of an eye of the human head.

The apparatus may comprise a first lens comprising a first one of the liquid crystal cell; and a second lens comprising a second one of the liquid crystal cell.

The field of view of the eye may be a first field of view of a first eye, and the first lens may be configured to be positioned in the first field of view, in use, and the second lens may be configured to be positioned in a second field of view of a second eye of the human head, in use.

The concentric electrodes may be grouped into concentric groups for inducing substantially confocal refractive index patterns in respective regions of the liquid crystal material, and the instructions may be configured to, with the at least one processor, cause the apparatus to apply an electrical potential difference across the concentric groups in parallel.

The apparatus may be at least one of: an augmented reality display device, a virtual reality display device or a mixed reality display device.

Some examples are described below in detail for the example of a device to function as a LC lens for a headset such as an augmented reality (AR) headset, but the techniques may also be applicable to other devices.

An example architecture for a Fresnel diffractive lens device comprises a plurality of Fresnel groups 8 of substantially concentric (within manufacturing tolerances) ring electrodes and one or more counter electrodes 6 on opposite sides of LC material 22 in a cell gap having a dimension at least partly defined/controlled by spacers 18. With reference to FIG. 3, each group 8 of concentric ring electrodes comprises a plurality of concentric ring electrodes 9 with resistive links 15 electrically connecting the concentric ring electrodes 9 in series. The resistive links 15 bridge gaps 13 between the concentric ring electrodes 9. Each Fresnel group 8 is configured such that the groups 8 together induce substantially confocal (e.g. confocal within a manufacturing tolerance of ±10%) refractive index (RI) patterns (and thus substantially confocal optical path length (OPL) profiles) in respective regions of the LC material 22. The electrode groups 8 are configured to be connected in parallel to a power source, so as to apply substantially the same potential difference across each electrode group 8 in the same radial direction. FIGS. 5a and 5b show examples of radial resistance profiles (electrical resistance (y-axis) against distance from common axis (100) of concentric electrode groups 8) for an example comprising three groups 8. For simplicity of illustration, FIG. 3 shows only a small number of concentric conductor rings 9 electrically connected in series via conductor links 15, but a Fresnel group 8 may comprise a much larger number of concentric conductor rings 9. The radially innermost and outermost concentric conductors 9 of the innermost Fresnel group A are connected to respective ones of the terminals 88, 86 via respective ones of the bus conductors 14, 12. The same is the case for all the other Fresnel groups 8 of concentric conductor rings.

FIG. 4 shows a cross-sectional representation of a device including the Fresnel groups 8 of concentric conductor rings of FIG. 2. The device comprises LC material 22 between two support components 2, 4. One of the support components comprises a support film (e.g. flexible plastics (organic polymer) film) supporting the above-mentioned elements including: bus conductors 12, 14; concentric conductor rings of the Fresnel conductor ring groups 8; conductive links 15; terminals 86, 88 connected to bus conductors 12, 14; and a terminal 89 connected to the counter conductor layer 6 supported by the other of the two support components. Terminals 86, 88 and 89 are bonded to respective pins 82, 94, 895 of a driver chip 80. One or more of the support components 2, 4 support a patterned layer of spacer material described further below.

The support components 2, 4 also support liquid crystal alignment layers 3 (such as mechanically rubbed polyimide layers) interfacing the liquid crystal material 22 in regions not occupied by spacers. The substrates 2, 4 on which the electrodes 6, 8 are supported may, for example, comprise flexible, organic polymer (plastics) support films.

The metal bus lines 12, 14 are used to apply a power supply (electric potential difference) in parallel across each Fresnel group 8 of electrodes. The metal bus lines 12, 14 may be provided at a level below the concentric electrode groups 8 via an electrically insulating layer 24 as shown in FIG. 7, for example. At least one metal bus line 14 contacts the innermost concentric ring electrode 9 of each group 8 through a respective via in the insulating layer 24, and at least one other metal bus line 12 contacts the outermost concentric ring electrode 9 of each group 8 through a respective via in the insulating layer 24.

The resistive links 15 between concentric ring electrodes within the groups 8 may or may not be part of the same patterned layer (e.g. conductive metal oxide layer such as an indium-tin-oxide (ITO) layer) that defines the concentric ring electrodes 9 of the groups 8. The resistive links 15 within an electrode group 8 are dimensioned so as to achieve the desired drops in electric potential between adjacent concentric ring electrodes 9 of the group 8. For example, the resistance of a link 15 between adjacent ring electrodes of a group 8 may be smaller or larger than the resistance of the next link 15 in the radial series of links; and the links 15 may provide a series of increasingly large or increasingly small resistances across the set of concentric ring electrodes 9 in an electrode group 8. A link 15 may, for example, comprise relatively narrow sections extending parallel to the adjacent concentric ring electrodes 9 connected by the link 15.

With reference to FIGS. 6 and 7, a layer of spacer material is formed and patterned in situ on the substrate 4 supporting the groups 8 of concentric ring electrodes, to form column spacers 18 dotted over the area bound by the radially outermost edge of the outermost group 8 of concentric electrodes. For example, the column spacers 18 may have a solid circular cross-section in a plane parallel to the plane in which the concentric ring electrodes lie, and may have a substantially rectangular cross-section in a plane perpendicular to the plane in which the concentric ring electrodes lie. The column spacers may, for example, have a diameter of about 20 microns or less. The layer of spacer material is patterned such that, within the area bound by the outermost edge of the radially outermost group 8 of concentric electrodes, column spacers 18 are at least disproportionately located in Fresnel re-set regions between regions in which the groups 8 of concentric ring electrodes are configured to induce substantially confocal refractive index patterns (and thus substantially confocal OPL profiles) in the LC material 22. According to one example, the column spacers 18 are at least disproportionately centered in regions between Fresnel groups 8 of concentric ring electrodes. Column spacers 18 centered in regions between Fresnel groups 8 of concentric ring electrodes may or may not partially overlap with concentric ring electrode(s) at the edge of groups 8. In FIGS. 6 and 7, 18a indicates examples of column spacers centered in regions between Fresnel electrode groups 8, and 18b and 18c indicate examples of column spacers not centered in regions between Fresnel electrode groups 8. Within the area bound by the radially outer edge of the radially outermost concentric Fresnel electrode group 8 (which radially outermost Fresnel electrode group is labelled E in the drawings), the percentage occupied by column spacers 18 of the total area of regions between Fresnel electrode groups 8 is greater than the percentage occupied by column spacers 18 of the total area of the Fresnel electrode groups 8. In an example, in which all column spacers have substantially the same individual cross-sectional area (in a plane parallel to the plane in which the ring electrodes lie), the area density of column spacers 18 in regions between Fresnel electrode groups 8 is higher than the area density of column spacers 18 in the regions of Fresnel electrode groups 8.

According to one example, all the column spacers located in a radially outermost annular area (area of common radial width and contiguous to the radially outer edge of the radially outermost concentric Fresnel electrode group 8) are located in re-set regions. According to one example, a radially outermost annular area in which all column spacers are located in re-set regions comprises at least about two-thirds (⅔) of the total area bound by the radially outer edge of the radially outermost concentric Fresnel electrode group 8.

Some column spacers 18 may be located in the regions of Fresnel electrode groups 8 in order to achieve a suitably uniform thickness of LC material 22 across the whole of the area bound by the outermost edge of the radially outermost Fresnel electrode group 8. In this example, the column spacers 18 that are within the regions of Fresnel electrode groups 8 are at least disproportionately located in sub-regions occupied by underlying elements that have a higher optical absorbance in the visible spectrum than the liquid crystal material 22 (hereafter referred to as opaque elements). In FIGS. 6 and 7, 18b indicates examples of column spacers in Fresnel electrode group regions occupied by opaque elements (such as the bus conductor 14), and 18c indicates examples of column spacers in Fresnel electrode group regions not occupied by opaque elements (such as the bus conductor 14). The optical absorbance in the visible spectrum is defined as the logarithm of the ratio of incident radiant power in the visible spectrum to transmitted radiant power through the element in the visible spectrum. The percentage occupied by column spacers 18 of the total area of Fresnel electrode group regions occupied by underlying opaque elements is greater than the percentage occupied by column spacers 18 of the total area of Fresnel electrode group regions not occupied by underlying opaque elements. In an example, in which all column spacers have substantially the same individual cross-sectional area (e.g. have the same cross-sectional diameter in a plane parallel to the plane in which the ring electrodes lie), the area density of column spacers 18 in Fresnel electrode group regions occupied by underlying opaque elements is higher than the area density of column spacers 18 in the Fresnel electrode group regions not occupied by underlying opaque elements. The underlying opaque elements may, for example, comprise underlying metal bus lines 12, 14 used to apply an electric potential difference across the Fresnel groups in parallel.

As mentioned above, the Fresnel electrode groups 8 are configured for applying a power supply (electric potential difference) in parallel across the groups 8, and without an electrical series connection between Fresnel groups 8. With reference to FIG. 6, at least one metal bus line 12 contacts corresponding outermost member ring electrodes 9 of each of Fresnel electrode groups A-E, and at least another metal bus line 14 contacts corresponding innermost member ring electrodes 9 of each of Fresnel electrode groups A-E.

In one example, each Fresnel reset region, between regions in which confocal RI patterns are induced upon activation of the Fresnel electrode groups 8, may be substantially fully occupied by an opaque element. For example, such opaque elements may be formed by patterning a layer of high absorbance material (higher absorbance in the visible spectrum than the LC material 22) formed in situ on the substrate supporting the concentric electrode groups 8. FIGS. 9 to 11 show representations of three examples.

In the example of FIG. 9, a patterned layer of spacer material defines continuous rings 26a of spacer material (annular spacers concentric with the electrode groups 8) in the Fresnel reset regions, and columns of spacer material 26b (column spacers) centered in other regions. Increasing the electrical conductivity of these rings 26a of spacer material (by including e.g. carbon black (as a high absorbance component) in the spacer material) and/or grounding the rings 26a of spacer material via COM lines, can provide an electrical shielding effect inhibiting electric fields generated on one side of a spacer ring 26a from influencing the LC material in the region on the opposite side of the spacer ring 26a. The solid spacer ring 26a can act to inhibit intermolecular interactions between liquid crystal material upon opposite sides of the spacer ring.

The example of FIG. 10 is the same as that of FIG. 9, except that the rings 26a of spacer material are broken in regions occupied by metal bus lines 36, but are otherwise continuous. In the example of FIG. 11, the rings 26a of spacer material are broken both in regions occupied by metal bus lines 36, and also in regions not occupied by metal bus lines 36, according to a regular pattern around the whole circumference of the ring. These breaks/gaps allow the movement of LC material from one side of the spacer ring 26a to the other side of the spacer ring 26a.

Disproportionately locating the spacers 18, 26a in these opaque regions can mitigate some of the disadvantageous side effects of the spacers, which may include the following. Spacers can cause issues with the alignment of the LC material, which can lead to optical scattering. Since the function of the device involves generating one or more refractive index patterns in the LC material 22, the spacers will have a different refractive index to the LC material in at least some regions of the LC material 22. Such differences in refractive index between the spacers and the LC material 22 can cause reflection and refraction at the interface between the spacers and the LC material 22, which also causes scattering. The fixed refractive index nature of the spacers can cause aberration to the wavefront of the light passing through the LC lens device. The above can also lead to diffractive effects, but undesirable constructive or destructive interference can be minimised by randomising spacer location.

The degree to which a viewer perceives scattering arising from spacers 18, 26b in non-opaque regions can be reduced by reducing the regularity of spacer positioning. In some examples, spacers 18, 26a that need to be located outside of opaque regions (e.g. outside of regions occupied by metal bus lines, regions occupied by high absorbance material in Fresnel reset regions etc.) are arranged randomly within the constraint of achieving a minimum distance between spacers for a given density of spacers (number of spacers per unit area). The minimum distance is determined as the distance required to ensure a sufficiently uniform cell gap across the whole of the area bound by the outermost concentric electrode. Poisson Disk Sampling is one example of a technique that can be used to achieve such a random arrangement of spacers.

Even for spacers located in non-opaque regions, the scattering itself can be reduced by e.g. (a) forming the spacers from a high absorbance material or a blend of materials comprising a high absorbance material, or (b) forming localised high absorbance elements in the regions of the spacers 18. FIG. 12 shows a representation of one example. The formation and patterning of a layer of spacer material is preceded by the formation and patterning of a layer of high absorbance material (material having a higher absorbance in the visible spectrum than the spacer material). The pattern created in the spacer material layer is substantially the same as the pattern created in the high absorbance material layer; the patterning of the high absorbance material layer forms islands 30 of high absorbance material in the locations in which spacers 28 are to be formed by patterning the spacer material layer. Patterning the high absorbance material layer is aimed at producing islands 30 of high absorbance material that are larger in cross-sectional size than the corresponding spacers 28 by an amount that tolerates some relative misalignment between the two patterning processes, i.e. some misalignment between the centres of the spacers 28 and the centres of the high absorbance islands 30. Even with some misalignment between the centres of the spacers 28 and the centres of the high absorbance islands 30, the spacers 28 can be expected to be wholly located in the regions of the high absorbance islands 30.

According to one (DC drive) example of activating the Fresnel groups 8 of concentric ring electrodes, the electric potential at the Fresnel groups 8 of concentric electrodes is constant in terms of polarity over time relative to the electric potential at counter electrode 6. According to another (AC drive) example for activating the concentric electrodes, the electric potential at the Fresnel groups 8 of concentric electrodes is alternated over time in terms of polarity relative to the electric potential at counter electrode 6, at a high switching frequency of e.g. about 80 Hz or above. The AC drive example may help to better protect the molecules of the LC material 22. According to one example: synchronised AC voltage waveforms having relatively high and low amplitudes are applied to terminals 88 and 86 respectively; and a reference COM electric potential (e.g. 0V) is applied to the third terminal 89 connected to the counter electrode 6. The sizes of the amplitudes of the synchronised AC voltage waveforms control the size of RI distribution generated in the LC material 22 and thus control the optical power (dioptres) of the device. In this simple example, three inputs (one input to counter electrode 6 (terminating in terminal 89) and two inputs to the two busbars 12, 14 (terminating in terminals 86, 88) are used), but other examples may include more busbars, and more respective inputs to those busbars via respective terminals.

The device described above may be referred to as an optical device and may, for example, function as or be used within a switchable lens device or a beam steering device. Such a device may be or comprise an adaptive optical lens comprising a device according to any of the examples herein. Such a device may be or comprise a headset, which may be referred to as a head-mounted display (HMD). The device described above is useful in a wide range of applications, including ophthalmic lenses (such as spectacle lenses), virtual reality (VR), mixed reality (MR) and augmented reality (AR) headsets; optical projectors; photographic devices; and communication devices.

For example, the device, which may be an LC optical lens device, may be used for a push lens, a pull lens or a combined push/pull lens of an augmented reality (AR) headset such as e.g. that shown in FIG. 13. The headset 40 comprises a support frame 42 supporting optical components arranged in optical series in front of the user eye. The optical components include: (i) a pull lens 48a, a waveguide 50 and a pull lens 48b for presenting a virtual object to the user; (ii) a front window/lens 44; and (iii) a variable dimmer device 46 between (ii) the front window/lens 44 and (i) the optical components for presenting a virtual object to the user.

At least one optical component such as one or more of the optical components shown in FIG. 13 may be considered to correspond to or be part of an assembly, which may be considered to be a display stack, comprising at least one liquid crystal cell according to examples herein. In examples, such as that of FIG. 13, such an assembly includes at least one liquid crystal cell according to examples herein, comprising liquid crystal material in a cell gap having a dimension at least partly defined by spacers. An assembly may include stack of liquid crystal cells according to examples herein. In the example of FIG. 13, the push lens 48a includes at least one liquid crystal cell (e.g. a stack of liquid crystal cells), the pull lens 48b includes at least one liquid crystal cell (e.g. a stack of liquid crystal cells), and the assembly includes the push lens 48a, the waveguide 50, the pull lens 48b, the variable dimmer device 46, which is an example of a luminance adjustment component, and the front window/lens 44. Examples in which an assembly includes two liquid crystal cells spatially separated from each other (e.g. such as an assembly with a push lens 48a with a liquid crystal cell and a pull lens 48b with a liquid crystal cell) may nevertheless be considered to include a stack of liquid crystal cells, for example where the liquid crystal cells are both within a field of view of the same eye as each other so that the liquid crystal cells lie in an optical path for light to travel through the assembly and into the eye. Liquid crystal cells of a stack may be aligned along a common optical axis. In some cases, though, optical axes of at least two of the liquid crystal cells of a stack may be offset from each other in a direction parallel to a plane of an electrode of at least one of the liquid crystal cells, provided that light traversing the assembly traverses the liquid crystal cells of the stack. FIG. 13 only shows the optical components for one half of the headset, but a matching set of optical components is also provided for the other half of the headset. An optical component may be referred to as an optical element.

The waveguides 50 of the headset respectively display left-and right perspectives of one or more virtual reality objects, by which the user perceives the one or more virtual reality objects as 3D objects. Alternatively, other mechanisms may be employed to display the left/right perspectives of the one or more virtual reality objects, such as e.g. laser projection.

The degree to which the user's left and right eyes need to rotate relative to each other such that the left and right perspectives of a virtual reality object are simultaneously directed onto the foveas (which are the parts of the retina responsible for sharp central vision necessary for activities for which visual detail is of primary importance) of respective left and right eyes of the user determines the distance at which the user perceives the virtual reality object to be. This mechanism is referred to as vergence.

The LC optical lens device described above may be used as an adaptive lens device to control the location at which the user's eyes perceive the left/right perspectives of a displayed virtual reality object in focus (i.e. not blurred), which location may be referred to as a focal plane. In other words, the LC optical lens device described above may be used as an adaptive lens device to control the degree to which the lenses in the user's eyes need to adapt to perceive the left and right perspectives of the virtual reality object in focus (i.e. not blurred). This adaptation mechanism of the lenses in the user's eyes is known as accommodation.

The LC optical lens device described above may be used to produce optical images (real or virtual) of the left/right perspectives of a virtual reality object substantially at the distance from the user's eyes at which the user perceives the virtual reality object to be located through the vergence mechanism discussed above. This may allow the user to perceive a focussed 3D image of the virtual reality object without disrupting the vergence-accommodation reflex, by which the focussing action of the lenses in the user's eyes (accommodation) is unconsciously linked to the above-mentioned rotation of the left and right eyes relative to each other (vergence). In other words, the LC optical lens device may be used to avoid or reduce the strain on the user's eyes that can arise from a conflict between the vergence and accommodation mechanisms (referred to as the vergence-accommodation conflict).

In FIG. 13, the headset 40 permits transmission of light from a real-world environment around the headset 40 at least partly through the optical components and into the user's eyes. In this example, the optical components are at least partly transparent. On a bright day, the luminance of the environment may be significantly higher outdoors than indoors, such as around 100 times higher. This can lead to a virtual object appearing washed out and difficult to see when the user operates the headset outdoors, unless the luminance of the light transmitted from the environment to the user is appropriately controlled. In FIG. 13, the variable dimmer device 46 controls the amount of light transmitted through the optical components and towards the eyes, e.g. so as to reduce the luminance of light from the environment transmitted towards the user in bright conditions, and may be used to provide ambient dimming to dim ambient light transmitted through the headset 40.

The variable dimmer device 46 may provide so-called global dimming, in which the luminance of the light from the environment is adjusted by substantially the same amount within an extent of a plane of the variable dimmer device 46 facing the user (e.g. to reduce the luminance of the light by substantially the same amount across an entire surface area of the variable dimmer device 46). In other words, global dimming can allow the luminance of the light transmitted through the variable dimmer device 46 to be controlled in a substantially spatially uniform manner (e.g. so as to provide a substantially spatially uniform reduction in the luminance across a field of view of the user). The variable dimmer device 46 may also or alternatively provide local dimming, in which the variable dimmer device 46 is adjustable to control the luminance of the light transmitted from the environment on an area-by-area basis (where an area may correspond to a single pixel or a plurality of pixels). Variable dimming may involve adjusting the luminance across less than all of the surface area of the variable dimmer device 46, such as within a sub-area which is smaller than the surface area of the variable dimmer device 46. In other cases, though, variable dimming may involve adjusting the luminance across the entire surface area of the variable dimmer device 46 but by different amounts in at least two portions of the surface area.

Although not shown in FIG. 13, it is to be appreciated that the headset 40 may be configured to obtain luminance data, e.g. from a light sensor of the headset 40, indicative of the luminance of the light within the environment of the headset 40. For example, if a first side 49a of the headset 40 is configured to face the user, with the headset 40 mounted on the head of the user, the headset 40 may include a light sensor to detect the luminance of light at a second side 49b of the headset 40, opposite to the first side 49a. The variable dimmer device 46 may be controlled at least partly based on the luminance data, so as to adjust the luminance of light transmitted from the second side of the headset 40 towards the user, to improve the visibility of the virtual object displayed to the user by the headset 40.

In the example of FIG. 13, a first lens comprising at least one liquid crystal cell of the examples herein (the push lens 48a) is located between the waveguide 50 and the eye, with the headset 40 in use. Light representative of the virtual object is generated and transmitted to the waveguide 50, which directs the light through the push lens 48a and into the eye. The push lens 48a has a focusing effect to focus the light representative of the virtual object so that the object appears in focus to the user. For example, the virtual object may be generated so that it is in focus at a focal plane of infinity. The push lens 48a may then bring the virtual object into focus at a focal plane which is closer to the user than infinity, to allow the user to focus on the virtual object more comfortably. The focal plane at which the virtual object is to be brought into focus, and hence the focusing power to be applied by the push lens 48a, may be determined based on eye tracking data, e.g. obtained by a suitable sensor as discussed further below, which is indicative of a direction in which the eye of the user is looking.

Prior to use of the headset 40, the external environment may appear in focus to the user. However, in the absence of the pull lens 48b, light from the external environment would be at least partly transmitted through the waveguide 50 and through the push lens 48a and would therefore be subject to the focusing effect provided by the push lens 48a. This would distort the external environment as viewed by the user through the headset 40. To compensate for the distortion introduced by the push lens 48a, the headset 40 of FIG. 13 includes a second lens (the pull lens 48b) positioned at an opposite side of the waveguide 50 to the push lens 48a. The pull lens 48b applies an appropriate focusing effect to light from the environment traversing the pull lens 48b to at least partially compensate for or otherwise reduce the focusing effect introduced by the push lens 48a. For example, the push and pull lenses 48a, 48b may provide opposite focusing effects to each other, e.g. with substantially equal magnitudes but opposite signs. As an example, one of the push and pull lenses 48a, 48b may provide a positive focusing power and the other one of the push and pull lenses 48a, 48b may provide a negative focusing power, which may be substantially equal in magnitude.

In examples at least one lens of examples herein (such as at least one of the push lens 48a and the pull lens 48b, and in some cases both the push and pull lenses 48a, 48b) each includes a so-called doublet of liquid crystal cells according to examples herein. A doublet is a stack of two liquid crystal cells. The focusing effect of a liquid crystal-based lens may depend on the polarization of the light incident on the lens. Rather than using a separate polarizer component, using a doublet such as this may provide an appropriate focusing effect with improved light transmission; in some examples this is achieved by positioning one liquid crystal cell of the doublet orthogonal to the other liquid crystal cell of the doublet, with respect to the respective orientation of polarization that each liquid crystal cell is configured to modify light for.

FIG. 13 shows an example of a push lens 48a and a pull lens 48b in combination with various other optical components. It is to be appreciated that a liquid crystal cell in accordance with examples herein can be used in combination with different optical component(s) than those shown in FIG. 13, to provide further flexibility in functionality. This may further reduce the size and/or weight of apparatus including the liquid crystal cell and/or improve optical performance of the apparatus. For example, an assembly, such as a display stack, including a liquid crystal cell in accordance with examples herein may include a reflection-reduction layer (such as an anti-reflection (AR) coating), which may be laminated to another optical component of the assembly, such as the front window/lens 44, and/or a protective layer (such as a hard coat) to protect the assembly from damage, e.g. due to abrasion, and/or wear due to exposure to environmental conditions. Further examples relate to a system comprising a liquid crystal device according to any of the examples herein, and a driver chip connected to the electrical terminals, such as the terminals 88, 86, 89 shown in FIG. 2. FIG. 14 illustrates a system 55 in accordance with these examples. With reference to FIG. 14, a system 55 according to some examples comprises a processor 51 operating on the basis of computer program code stored in memory 52 to control an image generation driver chip 53 to cause an image generation system to generate images of left/right perspectives of one or more virtual reality objects, by which the user may perceive 3D images of the virtual reality objects, and display the images via the waveguide 50. Although not shown in FIG. 14, it is to be appreciated that there may be two waveguides: one to display an image of a left perspective of a virtual reality object to a left eye and another to display an image of a right perspective of a virtual reality object to a right eye, as discussed further with reference to FIG. 13. There may further be two image generation systems: one to generate the image of the left perspective of the virtual reality object and another to generate the image of the right perspective of the virtual reality object (although in some cases a single image generation system may generate both images or an image generation system may generate a single image to be displayed to both eyes). An image generation system is discussed further below with reference to FIG. 15. Inputs from sensors 54 feed into the processor 51 to enable the processor 51 to control positions at which the virtual reality objects are displayed by the waveguide 50, for seamless overlay of the one or more virtual reality objects into the user's view of the user's real environment.

Based on inputs fed into the processor from one or more sensors sensing the movement of the user's eyes and/or based on the content being displayed by the waveguides 50, the processor controls the adaptive lens driver chip 80 to control the electrical inputs to terminals 86, 88, 89 to achieve the optical focussing power (Dioptres) required to achieve the above-described generation of optical images of the display output of the waveguides at a distance from the user's eyes at which the virtual content that the user is determined to be looking at (e.g. through tracking of the user's eyes) is intended to be perceived by the user (through the vergence mechanism described above).

Based on inputs fed into the processor 51 from one or more sensors 54 sensing the movement of the user's eyes and/or based on the content being displayed by the waveguides 50, the processor 51 controls the adaptive lens driver chip 80 to control the electrical inputs to terminals 86, 88 to achieve the optical focussing power (Dioptres) required to achieve the above-described generation of optical images of the display output of the waveguides at a distance from the user's eyes at which the virtual content that the user is determined to be looking at (e.g. through tracking of the user's eyes) is intended to be perceived by the user (through the vergence mechanism described above). A driver chip is an example of a controller, which may be implemented in hardware, e.g. via suitably configured circuitry. In some cases, a driver chip may include or be considered to implement at least one processor.

FIG. 15 illustrates schematically hardware architecture of apparatus 60 according to further examples. The apparatus 60 comprises at least one liquid crystal cell in accordance with examples herein. In FIG. 15, the apparatus 60 is configured to be mounted on human head, e.g. a head of a user, with a liquid crystal cell positioned in a field of view of an eye of the head, in use. In the example of FIG. 15, the apparatus 60 is an AR headset for displaying a virtual image to a wearer of the headset, and may be similar to or the same as the headset 40 of FIG. 13. In other examples, though, apparatus including a similar hardware architecture to the apparatus 60 of FIG. 15 may be configured for a different purpose, may include additional components and/or may omit at least one of the components illustrated in FIG. 15.

The apparatus 60 of FIG. 15 includes an optical system 62, an image generation system 64, at least one processor 66, storage 68, at least one sensor 70, a user input/output interface 72, a communications system 74 and at least one further hardware system 76. Components of the apparatus 60 are connected to each other via at least one bus 78, which may be or include any suitable interface or bus for transferring data between the illustrated components.

The optical system 62 includes a first assembly and a second assembly, which in this example are a first display stack 62a and a second display stack 62b, respectively. The first display stack 62a comprises a first set of optical components, e.g. arranged as a stack of layers. The apparatus 60 is configured to permit at least partial transmission of light from an external environment through the first display stack 62a and towards a first eye of the user, with the apparatus 60 in use and mounted on the head. In other words, where the apparatus 60 has a first side configured to face the user, in use (e.g. the first side 49a of FIG. 13), the first display stack 62a is arranged for directing light from the second side towards the first eye (in this case, through the first display stack 62a). The first display stack 62a in this case includes the optical components shown in FIG. 13, i.e. the push lens 48a, the waveguide 50, the pull lens 48b (where the push and pull lenses 48a, 48b are each an example of an optical device according to examples herein), the variable dimmer device 46 and the front window/lens 44. The push lens 48a and/or the pull lens 48b of the first display stack 62a may be considered to be a first lens comprising a first at least one of the liquid crystal cells according to examples herein. The first lens is configured to be positioned in a first field of view of a first eye, e.g. the first eye of a user, in use.

In FIG. 15, the second display stack 62b comprises a second set of optical components, which in this example is the same as the first set of optical components but configured to transmit light towards a second eye of the user, with the apparatus 60 in use. In other words, the second display stack 62b is arranged to direct light from the second side of the apparatus 60 towards the second eye. Hence, in this example, the push lens and/or the pull lens of the second display stack 62b may be considered to be a second lens comprising a second at least one of the liquid crystal cells according to examples herein. The second lens is configured to be positioned in a second field of view of a second eye, e.g. the second eye of the user, in use. It is to be appreciated that the first lens may be visible to solely the first eye or to both the first and second eye, in use, and the second lens may be visible to solely the second eye or to both the first and second eye, in use.

A spatial arrangement of elements of the second display stack 62b in at least one layer of the stack may mirror the spatial arrangement of corresponding elements of the first display stack 62a in the corresponding layer of the stack of the first optical arrangement 62a as reflected in a sagittal plane of the apparatus 60 (which may be referred to as a longitudinal plane of the apparatus 60, and e.g. separates left and right sides of the apparatus, with the apparatus in use). In other cases, though, the first and second display stacks 62a, 62b may have a different structure from each other. It is to be appreciated that the optical system 62 may include further components, e.g. further optical components, not shown in FIG. 15.

The apparatus 60 also includes an image generation system 64 to generate an image of a virtual object to be displayed to the user of the apparatus 60 so that the virtual object appears to the user to be overlaid on top of the external environment, which is at least partly visible to the user through the optical system 62. The image generation system 64 may be or include a display device to generate an image (e.g. of a virtual object) for display by the apparatus 60 to the user. The display device may be a liquid crystal display (LCD) device, a light emitting diode (LED) display device such as an organic light emitting diode (OLED) display device, an electroluminescent (EL) display device and so forth. In the example of FIG. 15, the image generation system 64 is in optical communication with the optical system 62. For example, the image generation system 64 may be housed by the support frame 42 if the apparatus 60 is in the form of the headset 40 of FIG. 13. Light generated by the image generation system 62 representing the virtual object may be transmitted to the optical system (e.g. to a waveguide such as the waveguide 50 shown in FIG. 13) either directly (e.g. without traversing another optical component) or via at least one further optical component. In some cases, the image generation system may include two display devices, a first one for the first eye and a second one for the second eye, e.g. if it is desired to display a first image to the first eye and a second image to the second eye. In other examples, a single display device may be used to generate an image to be display to both the first and second eyes.

In the example of FIG. 15, the image generation system 64 is shown as a separate system from the optical system 62. In other examples, though, the image generation system may form part of the optical system. For example, an assembly, such as a display stack, of the optical system may include an image generation system, such as a display device.

The at least one processor 66 of the apparatus 60 may be a single processor or a plurality of processors of one or more types. Components of the at least one processor 66 may be implemented using suitably programmed hardware, e.g. in the form of circuitry. The at least one processor 66 may include a central processing unit (CPU), a graphics processing unit (GPU) and/or a neural processing unit (NPU), which may be referred to as a neural network accelerator.

In some examples, apparatus such as the apparatus 60 of FIG. 15 includes driving circuitry connected to at least one electrical connection connected to an electrode of the liquid crystal cell (such as the terminals 86, 88 discussed above) to apply a potential difference across one or more electrodes or electrode groups of the liquid crystal cell. The potential difference applied (such as a magnitude and/or timing of the potential difference applied) may be determined by the at least one processor 66 and/or by the driving circuitry, such as by a controller implemented by at least a portion of the driving circuitry, based on the instructions stored in the storage.

If the potential difference is determined by the driving circuitry, the determination of the potential difference may be instigated by instructions received from the at least one processor, such as instructions indicative that a virtual object is to be displayed and that one or more electrode sets are thus to be activated so that the virtual object appears in focus to the user. In this way, the driving circuitry may be agnostic to the at least one processor from which the instructions are received. In other words, the operation of the driving circuitry may for example be independent of the at least one processor used to control the driving circuitry, such that the same effect can be achieved irrespective of the at least one processor coupled to the driving circuitry (provided the at least one processor provides an appropriate indication to the driving circuitry to cause the driving circuitry to determine a suitable potential difference).

The potential difference may be applied to the electrical connection(s) by at least one driver of the driving circuitry, such as the adaptive lens driver chip 80 of FIG. 14, which is an example of a driver. Application of a potential difference by the at least one driver may be considered to amount to so-called “driving” of the electrode pattern(s), via the electrical connection(s). The driving circuitry may be in the form of at least one system-on-a-chip (SoC).

The storage 68 may be or include computer-useable volatile and/or non-volatile memory. The storage 68 may comprise random access memory (RAM) and/or read-only memory (ROM). The storage 68 may be removable or non-removable from the apparatus 60. The storage 68 stores instructions for controlling the apparatus 60 in accordance with examples herein, e.g. to activate one or more electrodes or electrode groups of a liquid crystal cell. Activation of an electrode group for example refers to applying a potential difference between at least two connectors connected to the electrode group (e.g. between the terminals 86 and 88, for example as shown in FIG. 2). The instructions may be in the form of computer-readable and/or executable instructions, e.g. computer program instructions. Although the storage 68 is shown as a separate component to the at least one processor 66 in FIG. 15, in some cases the storage 68 may be or include internal storage of the at least one processor 66, in which cases the at least one processor 66 and the storage 68 may be at least partly integrated into the same system or component.

The at least one sensor 70 in this example is configured to obtain eye tracking data of the apparatus, in use, which for example indicates a direction in which at least one eye of the user is looking, as the skilled person will appreciate. Eye tracking data may be obtained for each eye, or the eye tracking data may be obtained for a single eye or for a combination of both eyes of the user. Suitable sensors for obtaining eye tracking data include a camera 70a for obtaining images of at least one eye of the user, an inertial measurement unit (IMU) 70b for determining an orientation of the apparatus 60 and at least one position sensor 70c such as a global positioning system (GPS) sensor to determine a location of the apparatus 60. As the skilled person will appreciate, an IMU 70b may include at least one accelerator or gyroscope for use in determining the orientation of the apparatus 60. The focusing effect of the at least one liquid crystal cell may be controlled based on the eye tracking data, e.g. so as to reduce user eye strain as described further above.

The apparatus 60 also includes a user input/output interface 72 via which a user can interact with the apparatus 60 to control aspects of the apparatus 60. For example, the user input/output interface 72 may be or include an input device such as a button, a touchscreen, a slider, a controller or any other suitable device for communicating user requests to the apparatus 60 to control the apparatus 60.

The apparatus 60 includes a communications system 74 for receiving data from a remote system, e.g. via a suitable telecommunications network, such as a wireless network, or via some other type of network or connection. The communications system 74 may include an input/output interface, such as a Bluetooth connector, a universal serial bus (USB) connector or a network connector, for receiving the data from the remote system.

The apparatus 60 of FIG. 15 includes at least one further hardware system 76 such as a power source, e.g. a battery, for providing electrical power to the electrical components of the apparatus 60.

The term “substantially” used herein may be considered to mean that two elements that are “substantially” the same are: the same within manufacturing tolerances, the same within measurement uncertainties and/or are within 5% of each other.

In addition to any modifications explicitly mentioned above, it will be evident to a person skilled in the art that various other modifications of the described examples may be made within the scope of the accompanying claims.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the examples herein may consist of any such individual feature or combination of features.

1. An optical device comprising:
at least one liquid crystal cell comprising liquid crystal material in a cell gap having a dimension at least partly defined by spacers, the liquid crystal cell comprising electrodes for inducing substantially confocal refractive index patterns in substantially concentric, first regions of the liquid crystal material; and within an area bound by an outer edge of an outermost one of the first regions, the spacers being at least disproportionately located in one or more re-set regions between the first regions.

2-34. (canceled)
